(19) United States
(12) Patent Application Publication
(10) Pub. No.: US 2023/0152212 A1
(43) Pub. Date: May 18, 2023

(54) NON-INVASIVE MECHANISM PROVIDING SIMULTANEOUS DETERMINATION OF VISCOSITY-TEMPERATURE VARIATION OF LUBRICANT

(71) Applicant: Tata Consultancy Services Limited, Mumbai (IN)

(72) Inventors: ABHIJEET GOREY, Kolkata (IN); RAJ RAKSHIT, Kolkata (IN); TAPAS CHAKRAVARTY, Kolkata (IN); CHIRABRATA BHAUMIK, Kolkata (IN); ARPAN PAL, Kolkata (IN); ARIJIT SINHARAY, Kolkata (IN)

(73) Assignee: Tata Consultancy Services Limited, Mumbai (IN)

(21) Appl. No.: 18/049,334

(22) Filed: Oct. 25, 2022

(30) Foreign Application Priority Data
Nov. 13, 2021 (IN) 202121052119

(51) Int. Cl. G01N 21/17; G01N 21/47; G01N 29/07; G01N 29/11; G01N 29/46

(52) U.S. Cl. CPC G01N 21/1702; G01N 21/4795; G01N 29/07; G01N 29/11; G01N 29/46; G01N 2201/06113

(57) ABSTRACT

Embodiments herein provide a method and system for a non-invasive mechanism providing simultaneous determination of viscosity-temperature variation of a lubricant for predicting machine health using a Photo Acoustic (PA) sensing mechanism, Laser-enabled swept frequency acoustic interferometry (LE-SFAI), wherein the lubricant produces acoustic wave only if it absorbs the laser irradiation, thus overcomes the limitation of ultrasound based SFAI through optical absorption based contrast and proper selection of laser excitation wavelength. A PA signal received from the lubricant is processed by a Vector Network Analyzer (VNA), then converted to time domain to obtain normalized first peak that corresponds to the PA signal generated by the lubricant. A squared rise time of the first peak is indicative of viscosity of the liquid and shift in the first peak is indicative of variation of the viscosity as temperature of the lubricant varies.

### PRIORITY CLAIM

This U.S. patent application claims priority under 35 U.S.C. § 119 to: Indian Patent Application No. 202121052119, filed on Nov. 13, 2021. The entire contents of the aforementioned application are incorporated herein by reference.

### TECHNICAL FIELD

The embodiments herein generally relate to field of machine health prediction and, more particularly, to a method and system for non-invasive mechanism providing simultaneous determination of viscosity-temperature variation of lubricant for predicting machine health.

### BACKGROUND

Condition monitoring of machine's health enables early diagnosis of fault, reducing the machine shutdowns for inspection and thereby increasing the productivity. The two common approaches used for machine condition monitoring are tribology and lubricant monitoring. While tribology deals with the science of wear of the machine, lubricant monitoring deals with the inspection of quality of lubricant flowing into the machine for inferring machine's health. Condition monitoring of lubricant to derive insight on machine health is critical in several industries including, aviation, manufacturing, automobile, etc., since changes in the inherent properties of lubricant are key performance indicators of performance of the lubricant in it's function as a protective layer for the machine. Viscosity is one of the major inherent properties of the lubricant as it affects the flow of the lubricant, and viscosity is inversely proportional to the temperature of the lubricant, implicitly indicating operating temperature of the machine.

Conventionally, kinematic viscometers are used to measure the viscosity of lubrication oil. However, this method is laborious and time consuming. Moreover, sudden change in viscosity of the oil can even cause a catastrophic failure of the machine. Thus, attempts have been made towards viscosity sensing using micro acoustic viscosity sensor or tuning-fork based vibrational sensors that can be used for online sensing of oil's viscosity. Although these sensing approaches can determine the change in viscosity, these types of existing approaches are very difficult to install in machines as these sensors are required to be embedded in the lubrication flow path. Non-invasive methods have been explored for deriving viscosity and temperature information of the lubricant, wherein ultrasound sensing is one of the most popular approach in the context of non-invasive and non-destructive mechanisms. In ultrasound sensing, the high frequency ultrasound signals are used to probe the lubricant sample and the reflected echo signals are analyzed. However, ultrasound based approaches require complex data analysis algorithms for the inhomogeneous samples (such as lubricant or lubrication oil in machines that may contain particulates, water, etc.). The technical challenge arises specifically for lubricants due to different particulates present in the flowing oil. Since the transmitted ultrasound signals are absorbed by the particulates, oil, water, etc. present in the oil, the received ultrasound signal would reflect the signature of all the contaminants in the oil. Therefore, it is technically challenging to extract the change in viscosity of the lubrication oil as a function of temperature.

Ultrasound based swept frequency acoustic interferometry (SFAI) is a good approach for different parameter measurements of homogenous liquid but difficult with heterogenous liquids, particularly when liquids are lubricants (for example, machine oil) that are contaminated with many impurities. The fact is that ultrasound based excitation can generate ultrasound from any, the liquid or its contaminants, and the measured parameter will be affected by the contaminant presence. This creates a technical challenge in accurate estimation of value of inherent property of the liquid or lubricant.

### SUMMARY

Embodiments of the present disclosure present technological improvements as solutions to one or more of the above-mentioned technical problems recognized by the inventors in conventional systems.

For example, in one embodiment, a method for a non-invasive mechanism providing simultaneous determination of viscosity-temperature variation of a lubricant is provided. The method includes initiating an iterative process of the viscosity-temperature variation determination of the lubricant, for a predefined number of successive time instances, wherein the lubricant is held by a container of a machine that is monitored for predicting machine health thereof.

The steps of an iteration (each iteration) for a current time instance comprising: a) triggering an excitation signal having a predefined frequency sweep for generating an intensity modulated Continuous-Wave (CW) laser via the CW laser diode placed in an excitation circuit, driven by the CW laser driver with DC power supply unit, to irradiate the lubricant using the intensity modulated CW laser. b) receiving, via the ultrasound sensor, a Photo Acoustic (PA) signal produced within the lubricant irradiated with the intensity modulated CW laser. c) Processing via the VNA, the PA signal with reference to the excitation signal to generate an in-phase (I) component and a quadrature phase (Q) component of the PA signal in a frequency domain. d) Generating a PA analytical signal in the frequency domain from the I component and the Q component. e) Generating a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d). f) Generating a normalized first peak by amplitude normalization of the first peak after time-windowing the first peak from the TTD PA signal. g) Determining a rise time (tᵣ) of the PA signal by computing a time interval of the normalized first peak to rise from a pre-defined minimum amplitude percentage of a peak amplitude of the normalized first peak to a maximum amplitude percentage of the peak amplitude. h) Determining a viscosity (μ) in terms of a viscosity feature, of the lubricant based on the rise time (tᵣ) of the first peak, wherein the viscosity feature is directly proportional to a squared rise time (tᵣ²). i) Determining an acoustic velocity of the PA signal based on the peaking time instance of the first peak and the distance (d). j) Determining a temperature (T) of the lubricant (108) from the acoustic velocity, wherein the temperature is inversely proportional to the acoustic velocity of the PA signal.

The method further records a) the viscosity (μ) of the lubricant (108) in terms of the viscosity feature and b) the temperature (T) of the lubricant 108 determined in each iteration.

Furthermore, the method analyzes whether a change in the viscosity (μ) with respect to the temperature (T) is constant over a defined operating temperature range of the machine.

Furthermore, the method predict health of the machine as approaching a failure state, if the change in the viscosity is beyond a variation threshold indicating a drop in quality of the lubricant beyond an acceptable limit.

Thereafter, the method generates an alert indicating health of the machine as approaching the failure state if the change in the viscosity is beyond the variation threshold.

In another aspect, a system for a non-invasive mechanism providing simultaneous determination of viscosity-temperature variation of a lubricant is provided. The system comprises a viscosity-temperature computation module, a Vector Network Analyzer (VNA), CW laser driver with DC power supply unit, CW laser diode (110); a lubricant, a collimator, a ultrasound sensor, wherein the viscosity-temperature computation module comprises a memory storing instructions; one or more Input/Output (I/O) interfaces; and one or more hardware processors coupled to the memory via the one or more I/O interfaces, wherein the one or more hardware processors are configured by the instructions to: initiate an iterative process of the viscosity-temperature variation determination of the lubricant, for a predefined number of successive time instances, wherein the lubricant is held by a container of a machine that is monitored for predicting machine health thereof.

The steps of each iteration for a current time instance comprising: a) triggering an excitation signal having a predefined frequency sweep for generating an intensity modulated Continuous-Wave (CW) laser via the CW laser diode placed in an excitation circuit, driven by the CW laser driver with DC power supply unit, to irradiate the lubricant using the intensity modulated CW laser. b) receiving, via the ultrasound sensor, a Photo Acoustic (PA) signal produced within the lubricant irradiated with the intensity modulated CW laser. c) Processing via the VNA, the PA signal with reference to the excitation signal to generate an in-phase (I) component and a quadrature phase (Q) component of the PA signal in a frequency domain. d) Generating a PA analytical signal in the frequency domain from the I component and the Q component. e) Generating a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d). f) Generating a normalized first peak by amplitude normalization of the first peak after time-windowing the first peak from the TTD PA signal. g) Determining a rise time (tᵣ) of the PA signal by computing a time interval of the normalized first peak to rise from a pre-defined minimum amplitude percentage of a peak amplitude of the normalized first peak to a maximum amplitude percentage of the peak amplitude. h) Determining a viscosity (μ), in terms of a viscosity feature, of the lubricant based on the rise time (tᵣ) of the first peak, wherein the viscosity feature is directly proportional to a squared rise time (tᵣ²). i) Determining an acoustic velocity of the PA signal based on the peaking time instance of the first peak and the distance (d). j) Determining a temperature (T) of the lubricant (108) from the acoustic velocity, wherein the temperature is inversely proportional to the acoustic velocity of the PA signal.

The system is further configured to record a) the viscosity (μ) of the lubricant (108) in terms of the viscosity feature and b) the temperature (T) of the lubricant 108 determined in each iteration.

The system is further configured to, analyze whether a change in the viscosity (μ) with respect to the temperature (T) is constant over a defined operating temperature range of the machine.

The system is furthermore configured to predict health of the machine as approaching a failure state, if the change in the viscosity is beyond a variation threshold indicating a drop in quality of the lubricant beyond an acceptable limit.

Thereafter, the system is configured to generate an alert indicating health of the machine as approaching the failure state if the change in the viscosity is beyond the variation threshold.

In yet another aspect, there are provided one or more non-transitory machine-readable information storage mediums comprising one or more instructions, which when executed by one or more hardware processors causes a method for a non-invasive mechanism providing simultaneous determination of viscosity-temperature variation of a lubricant

The method includes initiating an iterative process of the viscosity-temperature variation determination of the lubricant, for a predefined number of successive time instances, wherein the lubricant is held by a container of a machine that is monitored for predicting machine health thereof.

The steps of each iteration for a current time instance comprising: a) triggering an excitation signal having a predefined frequency sweep for generating an intensity modulated Continuous-Wave (CW) laser via the CW laser diode placed in an excitation circuit, driven by the CW laser driver with DC power supply unit, to irradiate the lubricant using the intensity modulated CW laser. b) receiving, via the ultrasound sensor, a Photo Acoustic (PA) signal produced within the lubricant irradiated with the intensity modulated CW laser. c) Processing via the VNA, the PA signal with reference to the excitation signal to generate an in-phase (I) component and a quadrature phase (Q) component of the PA signal in a frequency domain. d) Generating a PA analytical signal in the frequency domain from the I component and the Q component. e) Generating a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d). f) Generating a normalized first peak by amplitude normalization of the first peak after time-windowing the first peak from the TTD PA signal. g) Determining a rise time (tᵣ) of the PA signal by computing a time interval of the normalized first peak to rise from a pre-defined minimum amplitude percentage of a peak amplitude of the normalized first peak to a maximum amplitude percentage of the peak amplitude. h) Determining a viscosity (μ), in terms of a viscosity feature, of the lubricant based on the rise time (tᵣ) of the first peak, wherein the viscosity feature is directly proportional to a squared rise time (tᵣ²). i) Determining an acoustic velocity of the PA signal based on the peaking time instance of the first peak and the distance (d). j) Determining a temperature (T) of the lubricant (108) from the acoustic velocity, wherein the temperature is inversely proportional to the acoustic velocity of the PA signal.

The method further records a) the viscosity (μ) of the lubricant (108) in terms of the viscosity feature, and b) the temperature (T) of the lubricant 108 determined in each iteration.

Furthermore, the method analyzes whether a change in the viscosity (μ) with respect to the temperature (T) is constant over a defined operating temperature range of the machine.

Furthermore, the method predict health of the machine as approaching a failure state, if the change in the viscosity is beyond a variation threshold indicating a drop in quality of the lubricant beyond an acceptable limit.

Thereafter, the method generates an alert indicating health of the machine as approaching the failure state if the change in the viscosity is beyond the variation threshold.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system providing an non-invasive mechanism for simultaneous determination of viscosity-temperature variation of a lubricant for predicting machine health, in accordance with some embodiments of the present disclosure.

FIG. 2 illustrates a viscosity-temperature computation module of the system of FIG. 1, in accordance with some embodiments of the present disclosure.

FIGS. 3A, 3b, and 3C (collectively referred as FIG. 3) show a flow diagram illustrating a method for simultaneous determination of viscosity-temperature variation of the lubricant for predicting machine health, using the system of FIG. 1, in accordance with some embodiments of the present disclosure.

FIG. 4A depicts magnitude spectra of a Photo Acoustic (PA) signal produced within the lubricant irradiated with the intensity modulated CW laser of the system 100 and having a predefined frequency sweep, in accordance with some embodiments of the present disclosure.

FIG. 4B depicts a Transformed Time Domain (TTD) PA signal obtained by processing the PA signal, in accordance with some embodiments of the present disclosure.

FIG. 5 depicts magnitude spectra of a PA signal produced by an example lubricant under test, in accordance with some embodiments of the present disclosure.

FIG. 6 depicts magnitude time-windowed normalized first peak obtained by processing the spectra of the PA signal to determine a rise time of the first peak, in accordance with some embodiments of the present disclosure.

FIG. 7 depicts magnitude time-windowed normalized first peaks obtained by processing the spectra of the PA signal at varying temperatures, in accordance with some embodiments of the present disclosure.

FIG. 8 depicts exponentially fitted viscosity versus temperature graph, in accordance with some embodiments of the present disclosure.

FIG. 9 depicts the viscosity obtained using system of FIG. 1 plotted against their corresponding temperature, in accordance with some embodiments of the present disclosure.

FIG. 10 shows the variation in speed of photo acoustic wave with respect to the temperature, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

In ultrasound based swept frequency acoustic interferometry (SFAI) it is difficult to obtain accurate estimation of inherent properties of heterogenous liquids. Embodiments of the present disclosure provide a method and system for a non-invasive mechanism providing simultaneous determination of viscosity-temperature variation of a lubricant for predicting machine health, which uses a Laser-enabled swept frequency acoustic interferometry (LE-SFAI). In principle, LE-SFAI disclosed herein differs from the conventional ultrasound based SFAI in the excitation used, which is done through intensity modulated laser radiation in LE-SFAI. For photo acoustic (PA) signal generation from any lubricant, required is a pulsed laser or intensity modulated laser. Pulsed laser is a very complex system which require lot of prerequisites such as desired temperature, humidity level, etc. for its operation, which is challenging in an industrial environment. Therefore, the method and system disclosed herein discloses utilizing an intensity modulated CW laser for the PA signal generation from the lubricant. The intensity modulated CW laser usage makes the system compact and cost effective, which can be easily deployed in industrial environments, effectively adding to the practical usability of the system.

The LE-SFAI enables determining the inherent properties of the lubricant, even for a heterogeneous liquid, with high accuracy. The properties of the lubricant such as density, viscosity temperature, sound attenuation in liquids or lubricants can be accurately determined. With the disclosed LE-SFAI approach the lubricant produces acoustic wave only if lubricant absorbs the laser irradiation, thus overcomes the limitation of conventional ultrasound based SFAI through optical absorption based contrast and proper selection of laser excitation wavelength.

The lubricant, upon absorption of intensity modulated laser undergoes localized heating thereby causing thermoelastic expansion and further it relaxes to produce ultrasound waves. The advantage of system disclosed herein lies in its optical absorption based ultrasound generation, which means that the ultrasound wave will be produced only if the lubricant absorbs the laser radiation and gets rid of the contaminants interference during measurement. This laser assisted ultrasound wave (also called the PA signal) contains significant information about the lubricant's inherent properties.

The PA signal, so generated by the lubricant is acquired using a Vector Network Analyzer (VNA), then converted to time domain to obtain a first peak corresponding to the PA signal generated by the lubricant. A squared rise time of the first peak is indicative of viscosity of the liquid and shift in the first peak is indicative of variation temperature of the lubricant.

The system, also referred to as the LE-SFAI based system, and the method enables to derive not only the individual parameter such as viscosity but variation of viscosity with respect to temperature. Since temperature is a critical factor associated with viscosity of the lubricant, the relative analysis between the viscosity and temperature disclosed herein serves as an more appropriate Key Performance Indicator (KPI) of a machine health status, enhancing prediction accuracy of lubricant and effectively the machine failure prediction.

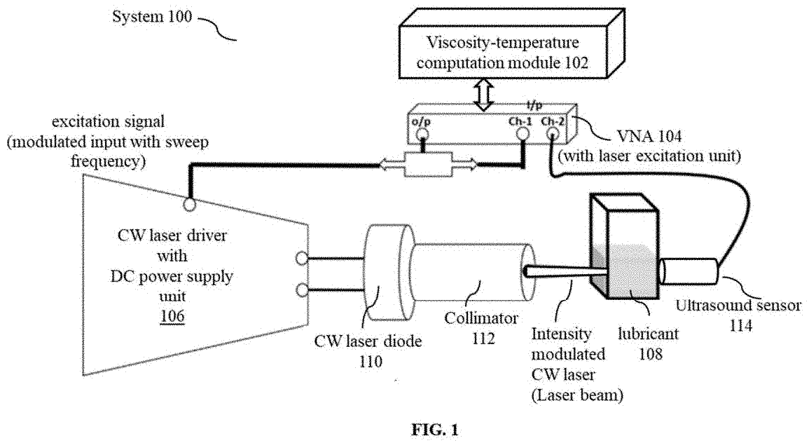

Referring now to the drawings, and more particularly to FIGS. 1 through 10, where similar reference characters denote corresponding features consistently throughout the figures, there are shown preferred embodiments and these embodiments are described in the context of the following exemplary system and/or method.

FIG. 1 is a functional block diagram of a system 100 providing an non-invasive mechanism for simultaneous determination of viscosity-temperature variation of a lubricant for predicting machine health, in accordance with some embodiments of the present disclosure.

A set up for the LE-SFAI technique used by the system 100 is depicted in FIG. 1. A VNA 104, for example, Bode-100™, provides excitation (sinusoidal frequency sweep) that acts as an excitation signal, which is used to frequency modulate a Continuous Wave (CW) laser generated using a CW laser diode 110 placed in an excitation circuit. Since, the current of this frequency sweep signal from VNA 104 is low, a CW laser driver with power supply unit 106 is added to provide the adequate current modulation to the excitation circuit. The CW laser driver with power supply unit 106 disclosed herein can provide the sinusoidal current modulation from 20 mA to 1.2 A maximum. The DC power supply is used to provide a proper bias and DC offset to the laser driver of the CW laser driver with power supply unit 106. Thus, the intensity of CW laser diode 110 is modulated through the current modulation from laser driver circuit. The selection of the CW laser diode 110 is based on the optical absorption curve of the lubricant 108 used in a machine under machine health monitoring. For example, for the lubricant such as lubrication oil (SAE-20W40), a TB-450 nm from Thorlabs™ Inc. USA CW laser diode, is used, that has wavelength 450 nm and maximum power of 1.6 watt. Thus, selection of the CW laser diode 110 is based on the lubricant 108 to be monitored and tested for viscosity variations. The example CW laser diode 110 used exhibits a sinusoidal power modulation from 60 milli Watt (mW) to 260 mW at a plane of the lubricant 108 under test. Thus, the power modulation of 200 mW (260-60=200 mW) causes the intensity of the CW laser diode 100 to modulate sinusoidally. In order to modulate the power or intensity of the CW laser diode 110, the current through the CW laser diode 110 is modulated. In an example implementation, the current is modulated with a predefined frequency sweep of 0.1 MHz to 1.2 MHz, which depends on the bandwidth of a ultrasound sensor 114 used.

This intensity modulated laser is focused with beam diameter of 2 mm using a collimator 112 with a collimated lens of focal length 50 mm onto a lubricant 108 108 present in a container in the machine set up. As understood based on the distance between the container and the CW laser diode 110, the collimator and the beam diameter can be adjusted accordingly. The lubricant 108 108 absorbs the laser radiation focused via the collimator 112 and produces the signal or PA waves. The PA signal so generated, has same frequency as of the predefined frequency sweep of the excitation signal to which the CW laser is modulated. The ultrasound sensor 114, V-303 SU™, used in one example implementation, has a 6-dB bandwidth of 1 MHz. As depicted in the FIG. 1, the ultrasound sensor 114 is coupled to the container with the acoustic gel for proper impedance matching. The PA signal acquired by the ultrasound sensor 114 is fed to one input of the VNA 104 and to the other input the reference excitation signal is fed. This reference signal is the same signal which is given to the CW laser driver unit 106. The acoustic signal data from the VNA 104, which is the PA signal, is retrieved into a memory 202 of a viscosity-temperature computation module 102 for obtaining its magnitude spectra and further signal processing to determine viscosity-temperature variation of the lubricant 108.

In one example implementation, since the heating of the lubrication oil happens at an elevated temperature of 80 deg C., the container used in the machine are designed accordingly.

Measuring Principle: The LE-SFAI technique disclosed herein, is a non-invasive approach to depict inherent property of fluid like viscosity and physical properties like temperature, by measuring the sound speed. Explained below is determination of viscosity in terms of a viscosity feature and temperature of the lubricant 108 by applying the analysis of time-domain signal known as ‘squared rise-time (tᵣ)’ along with the traditional feature speed of sound. In the system 100, the frequency swept signal f={fₛₜₐᵣₜ, . . . , fₛₜₒₚ} is fed to the CW laser driver with power supply unit 106, which in turn modulates the intensity CW laser diode 110 as per the frequency swept signal. Thus, the frequency swept intensity-modulated CW laser diode 110 is used to irradiate the lubricant 108 placed in the stationary and transparent sample container. Upon the CW laser excitation, the lubricant 108 absorbs the laser and generates photo acoustic waves (PA signal) at the same frequency as that of laser excitation (predefined frequency sweep). Depending on the dimension of the container (internal width in case of rectangular container), a resonance condition is set up whenever the integer multiple of the half wavelength of the acoustic wave fits into the internal width of the container. As shown in FIG. 1, in one implementation a rectangular box of internal width W, is used such that the resonance condition is set-up in the lubricant 108 and standing wave is formed if integer multiple of half wavelength fits inside W and can be mathematically it can be expressed as:

$$W = n . \frac{λ}{2} \qquad ( 1 )$$

Where, n is the integer 1, 2 . . . n and λ is the wavelength corresponding to the excitation frequency. A can also be expressed as the ratio of the acoustic velocity (v) of acoustic waves in fluid to the frequency (f) of excitation.

$$λ = \frac{v}{f} \qquad ( 2 )$$

Following to equation 1 and 2 consecutive resonance peaks can be observed by equation 3 as shown—

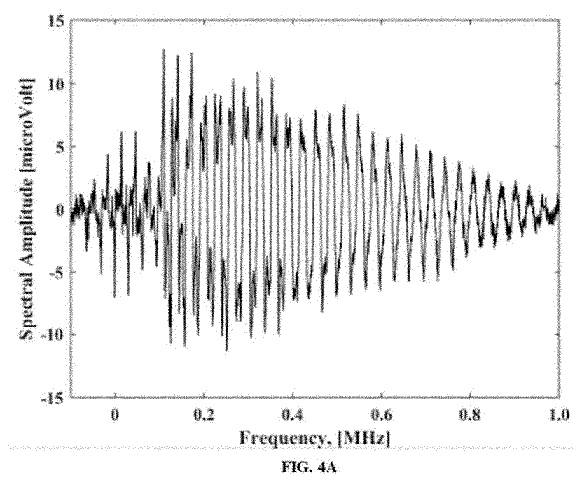

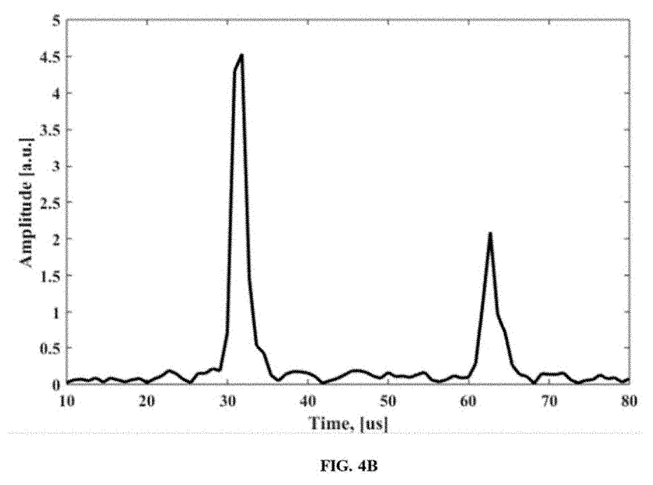

v=2WΔf (3)

Where, Δf represents the difference between two consecutive resonance peaks. FIG. 4A shows the magnitude spectra of frequency swept laser enabled acoustic interferometry. From this spectra, Δf can be computed, thereby determining the speed of sound. By knowing the speed of sound in a given medium and thickness of container some physical properties such as time of flight, temperature of the medium can be depicted. However, with only frequency domain parameters, it is difficult to determine the information about the inherent property of the lubricant 108 such as the viscosity. Moreover, in the SFAI the transformed time-domain approach provides the significant information about the lubricant's (interchangeably referred herein after as sample) properties. Therefore, the technique disclosed by the system 100 utilizes the Inverse Fourier Transform (IFT) algorithm to obtain the time-domain signal of the corresponding magnitude spectra of frequency swept laser enabled acoustic interferometry.

FIG. 4B shows a transformed time-domain (TTD) PA signal. The TTD PA signal exhibit multiple peaks as shown in as P1, P2. The first peak (P1) represents the time taken by the acoustic signal to reach the ultrasound sensor 114 from the point of its generation. The subsequent peaks (P2) result from the reflection of the acoustic signal back and forth from the walls of the sample container. It can be observed that the amplitude of the peak reduces with the increase in path length of the acoustic wave in the medium. The important reason for this phenomenon is the acoustic absorption in the medium. As the photo acoustic waves propagate in the medium it gets absorbed by the sample or a medium thereby reducing its amplitude. Therefore, the amplitude corresponding to peak P1 is maximum followed by P2. The reduction in the amplitude (attenuation) of acoustic wave, as it propagates in the medium is dependent on the inherent properties of the lubricant 108. Conventionally, by calculating the attenuation of the TTD PA signal, inherent properties of the lubricant (fluid sample) can be inferred.

The conventional ultrasound SFAI has limitations, that are overcome by the LE-SFAI based system 100 disclosed herein. The limitations are explained below.
1) To determine the attenuation of a time domain acoustic signal at least two peaks are required.
2) If there is a strong acoustic absorption by the sample then it is very difficult to obtain the second peak.
3) The acoustic attenuation is dependent on the path length of the acoustic wave. Hence, if the path length of acoustic wave is much higher (sample container is of greater width) than it is difficult to obtain the second peak. Therefore, it puts a limitation on the size of sample container that has to be considered.
4) In the system 100 disclosed herein, the PA signal (acoustic signal) is generated in the sample by irradiating it with the intensity modulated CW laser diode. Since, the inherent power of the laser diode is low, the acoustic signal generated by this method is of very less amplitude. Hence, for a higher path length it is extremely difficult to obtain the second peak in the TTD PA signal. To overcome this problem, a very high power CW laser diode with complex electronic circuit can be used.

From the above points, it is clear that obtaining two peaks to determine inherent property of a fluid is challenging many practical cases. Thus, this system discloses an approach that relies on only a single or first peak from the TTD PA signal to determine inherent property of the lubricant and overcomes the practical implementation limitation mentioned above. It is observed based on experimental analysis that the square of the rise-time (tᵣ²) of the first peak of TTD PA signal is related to the inherent property (viscosity) of the fluid. Hence, this the system disclosed herein utilizes tᵣ of the first peak to depict the viscosity of the fluid, in terms of the viscosity feature.

Rise-time: A rise time (tᵣ) of the PA signal is determined by computing a time interval of the normalized first peak to rise from a pre-defined minimum amplitude percentage of a peak amplitude of the normalized first peak to a maximum amplitude percentage of the peak amplitude. The rise time here, is defined as the time required by the first peak of TTD acoustic signal to reach from 10% to 90% of its maximum value.

Literature reveals that the rise time of a time-domain signal is related to the bandwidth (BW) of its corresponding frequency-domain signal. The relation between rise-time and bandwidth can be given by equation 4 as:

$${t}_{r} ∝ \frac{1}{B . W .} \qquad ( 4 )$$

Also, for Newtonian fluid, the inherent property can be inferred from its acoustic frequency spectra as given by equation 5.

$$μ = \frac{2. ρ . α . {v}^{3}}{{f}^{2}} \qquad ( 5 )$$

Where, μ is the viscosity, f is the frequency of acoustic signal, α is the acoustic attenuation factor, ρ is the fluid density, v is the acoustic velocity of acoustic wave. Thus, equation 5 show that the viscosity of any Newtonian fluid exhibits the inverse squared relation with the frequency. Also, in case of viscous fluid, for a change in viscosity, photoacoustic spectra shows a shift in higher frequency (fₕ) component whereas the lower frequency (fₗ) component remains same. Bandwidth of the photoacoustic spectra is the difference of highest and lowest frequency component. Therefore, the variation in the bandwidth would be due to the shift in its higher frequency component (as in case of PA spectra fₗ remains the same). Since, in PA spectra only fₕ changes, it would be similar to the change in acoustic signal's frequency ‘f’. Hence, equation 4 can be re-written as:

$${t}_{r} ∝ \frac{1}{f} \qquad ( 6 )$$

On squaring both sides of equation 6

$${t}_{r}^{2} ∝ \frac{1}{{f}^{2}} \qquad ( 7 )$$

Using equations 5 and 7, it can be observed that—

μ∝tᵣ² (8)

Hence, equation 8 suggests that the viscosity of Newtonian fluid varies as a square of rise time (tᵣ²) of the first peak of TTD PA signal. Thus, the viscosity temperature computation module 102 uses the above analysis to depict the viscosity information of the Newtonian fluid such as lubrication or engine oil.

Viscosity of the lubrication oil varies with the temperature. Thus, in order to monitor the quality of lubrication oil it is essential to observe the change in viscosity of the lubricant with temperature. Literature reveals that for lubrication oil, temperature is inversely related to the speed of acoustic wave. Since, the sample container used in this entire study is same, the acoustic path length becomes identical and therefore, the shift in position of the first peak of TTD PA signal can provide the information about the speed of PA signal.

Therefore, from the first peak of TTD PA signal, the information about the viscosity and the temperature of the fluid can be inferred by obtaining the square of the rise time and position of the first peak, respectively.

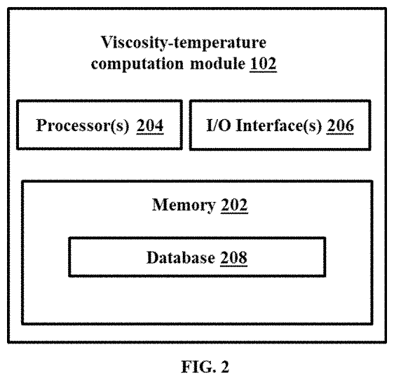

FIG. 2 illustrates an viscosity-temperature computation module 102 of the system 100 depicted in FIG. 1, in accordance with some embodiments of the present disclosure. In an embodiment, the viscosity-temperature computation module 102 includes a processor(s) 204, communication interface device(s), alternatively referred as input/output (I/O) interface(s) 206, and one or more data storage devices or a memory 202 operatively coupled to the processor(s) 204. The viscosity-temperature computation module 102 with one or more hardware processors 204 is configured to execute functions of one or more functional blocks of the viscosity-temperature computation module 102.

Referring to the components of the viscosity-temperature computation module 102, in an embodiment, the processor(s) 204, can be one or more hardware processors 204. In an embodiment, the one or more hardware processors 204 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 204 are configured to fetch and execute computer-readable instructions stored in the memory 102. In an embodiment, the viscosity-temperature computation module 102 can be implemented in a variety of computing systems including laptop computers, notebooks, hand-held devices such as mobile phones, workstations, mainframe computers, servers, and the like.

The I/O interface(s) 206 can include a variety of software and hardware interfaces, for example, a web interface, a graphical user interface to display the generated target images and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

The memory 202 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

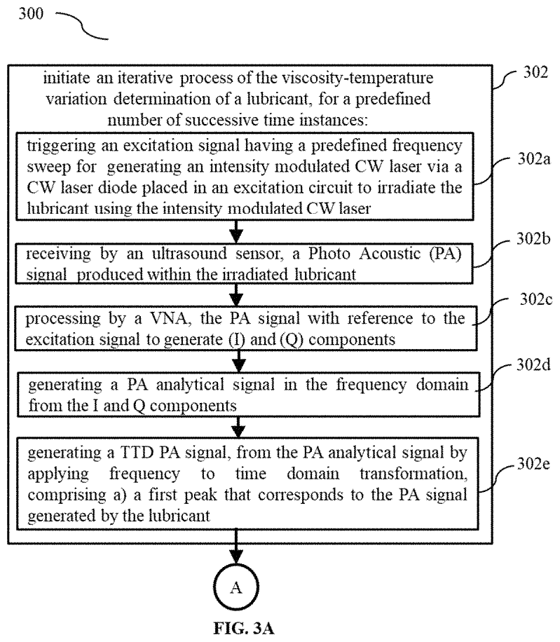

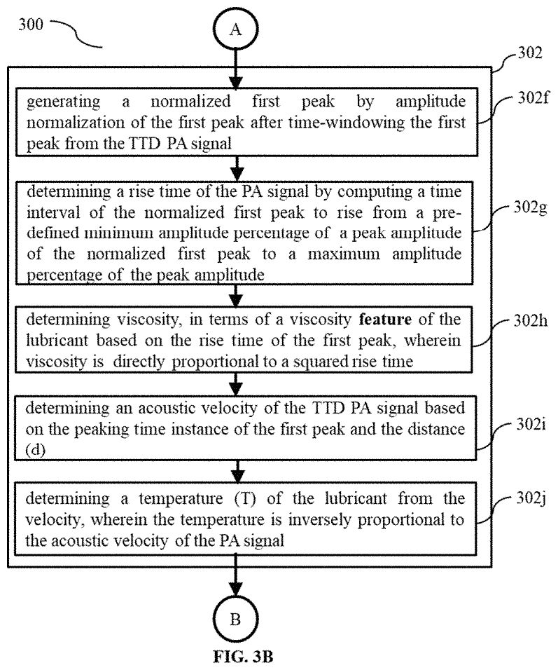

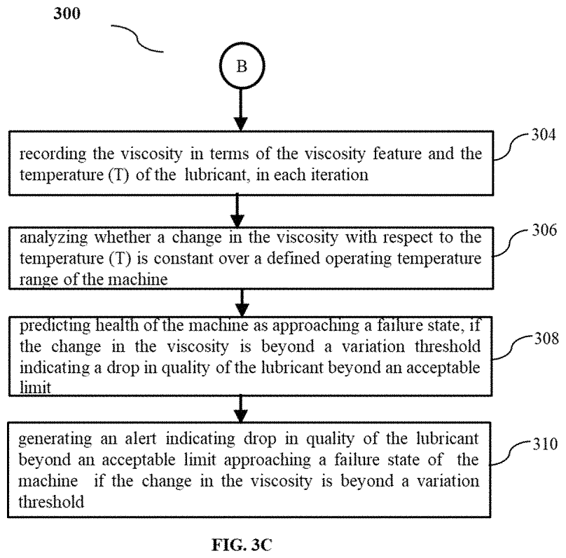

Further, the memory 102 includes a database 208 that stores the PA signal, the analytical PA signal, converted time domain PA analytical signal, the first peak information, corresponding rise time and so on. Further, the memory 102 may comprise information pertaining to input(s)/output(s) of each step performed by the processor(s) 204 of the viscosity-temperature computation module 102 and methods of the present disclosure. In an embodiment, the database 208 may be external (not shown) to the viscosity-temperature computation module 102 and coupled to the viscosity-temperature computation module 102 via the I/O interface 206. Functions of the components of the system 100 and the viscosity-temperature computation module 102 are explained in conjunction with flow diagram of FIG. 3 and experimental analysis depicted in FIGS. 4A through 10.

FIGS. 3A through 3C (collectively referred as FIG. 3) is a flow diagram illustrating a method 300 for simultaneous determination of viscosity-temperature variation of the lubricant for predicting machine health, using the system of FIG. 1, in accordance with some embodiments of the present disclosure.

In an embodiment, the system 100 comprises the viscosity-temperature computation module 102, which comprises one or more data storage devices or the memory 202 operatively coupled to the processor(s) 204 and is configured to store instructions for execution of steps of the method 300 by the processor(s) or one or more hardware processors 204. The steps of the method 300 of the present disclosure will now be explained with reference to the components or blocks of the system 100 as depicted in FIG. 1 and FIG. 2 and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 300, at step 302 of the method 300, the one or more hardware processors 204 initiate an iterative process of the viscosity-temperature variation determination of a lubricant, for a predefined number of successive time instances, wherein the lubricant is held by a container of a machine that is monitored for predicting machine health thereof. The steps of each iteration for a current time instance comprise:
a) Triggering (302a) an excitation signal having the predefined frequency sweep for generating the intensity modulated Continuous-Wave (CW) laser via the CW laser diode 110 placed in the excitation circuit to irradiate the lubricant using the intensity modulated CW laser.
b) Receiving (302b), by the ultrasound sensor 114, the Photo Acoustic (PA) signal produced within the lubricant irradiated with the intensity modulated CW laser.
c) Processing (302c), by the VNA 104, the PA signal with reference to the excitation signal to generate an in-phase (I) component and a quadrature phase (Q) component of the PA signal in a frequency domain.
d) Generating (302d), by the one or more hardware processors a PA analytical signal in the frequency domain from the I component and the Q component.
e) Generating (302e), by the one or more hardware processors 204, a Transformed Time Domain (TTD) PA signal from the PA analytical signal in the frequency domain by applying frequency to time domain transformation, for example an Inverse Fourier Transform (IFT). The TTD PA signal comprises a) the first peak that corresponds to the PA signal produced within the lubricant, and b) subsequent one or more descending peaks generated as a result of reflection of the PA signal back and forth from walls of a container holding the lubricant. As mentioned in FIG. 1, a peaking time instance of the first peak is indicative of time elapse of the PA signal in reaching the ultrasound sensor 114 from a point of generation of the PA signal inside the container at a distance (d).
f) Generating (302f), by the one or more hardware processors 204, a normalized first peak by amplitude normalization of the first peak after time-windowing the first peak from the TTD PA signal.
g) Determining (302g), by the one or more hardware processors 204, the rise time (tᵣ) of the PA signal by computing the time interval of the normalized first peak to rise from the pre-defined minimum amplitude percentage of the peak amplitude of the normalized first peak to a maximum amplitude percentage of the peak amplitude.
h) Determining (302h), by the one or more hardware processors, a viscosity (μ) in terms of the viscosity feature of the lubricant based on the rise time (tᵣ) of the first peak, wherein the viscosity feature is directly proportional to the squared rise time (tᵣ²).
i) Determining (302i), by the one or more hardware processors 204, the acoustic velocity (v) of the PA signal from the peaking time instance of the first peak and the distance (d).
j) Determining (302j), by the one or more hardware processors 204, a temperature (T) of the lubricant from the acoustic velocity, wherein the temperature is inversely proportional to the acoustic velocity of the PA signal.

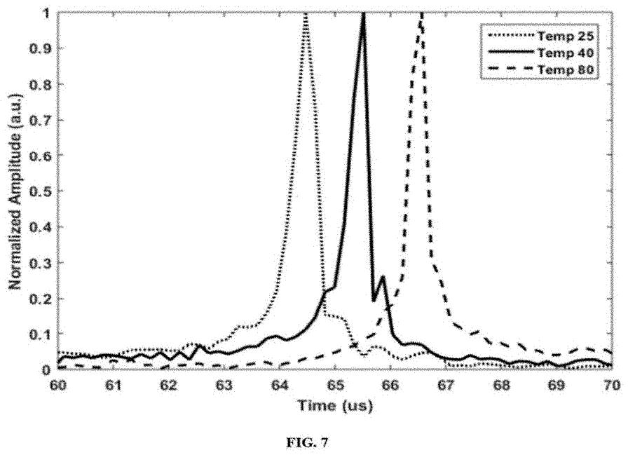

At step 304 of the method 300, the one or more hardware processors 204 record a) the viscosity (μ), determined in terms of the viscosity feature of the lubricant and b) the temperature (T) of the lubricant determined in each iteration. This is depicted in graphical analysis in FIG. 7

At step 306 of the method 300, the one or more hardware processors 204 analyze whether a change in the viscosity (μ) with respect to the temperature (T) is constant over a defined operating temperature range of the machine.

At step 308 of the method 300, the one or more hardware processors 104 predict health of the machine as approaching a failure state, if the change in the viscosity is beyond a variation threshold indicating a drop in quality of the lubricant beyond an acceptable limit.

At step 310 of the method 300, the one or more hardware processors 204 generate an alert indicating drop in quality of the lubricant (108) beyond the acceptable limit with the machine approaching the failure state. The variation threshold, defining the acceptable limit can be defined by subject matter experts and the actual industrial environment, where the system 100 is deployed for machine health monitoring.

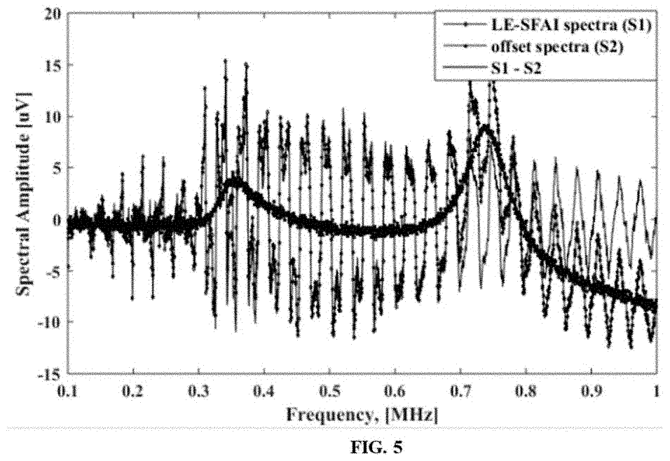

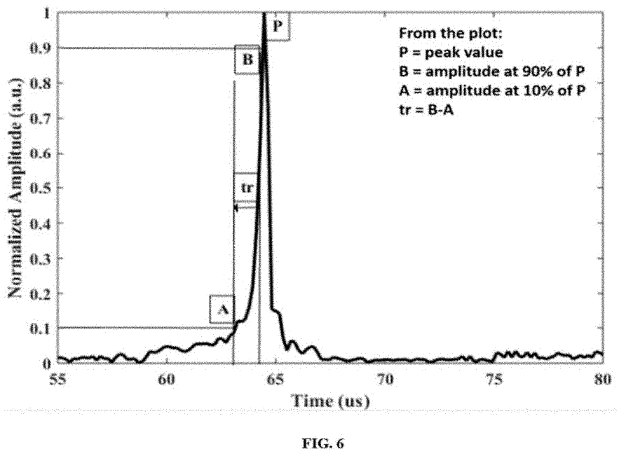

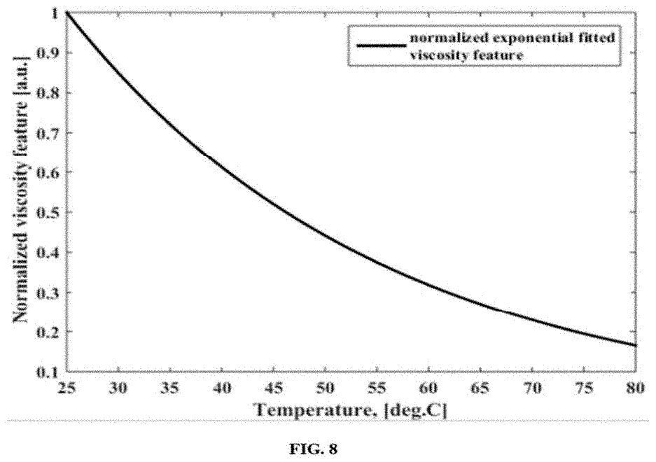

Result and Discussion: This study focuses on determining the quality of lubrication oil by depicting it is the viscosity and the temperature information. For experiments, 200 ml oil (lubricant) is collected in the glass container. This oil is heated till the temperature of the oil rise to 80 deg. C. and immediately the laser source is triggered to irradiate the oil sample and the photoacoustic signal generated by the sample, is acquired. Subsequently, the acoustic signal is acquired for every 10 deg C. fall in temperature and acquired. FIG. 5 depicts one of the spectra of the PA signal (LE-SFAI). The offset in the magnitude spectra is due to the system's response overlapped with the PA signal. For offset removal, the system's response is recorded in the VNA with similar experimental settings, except that the CW laser irradiation to the sample is blocked such that no PA signal is generated by the sample. Further, the offset response is subtracted from the PA signal, interchangeably referred to as acoustic signal, and the offset removed magnitude spectra is shown. This offset removed magnitude spectra is used with the Inverse Fourier Transform algorithm to obtain the corresponding time-domain acoustic signal. Subsequently, this TTD PA signal is normalized with respect to its maximum amplitude and time windowed to obtain the zoomed TTD PA signal near its first-peak (P1). FIG. 6 show the time windowed TTD indicating the rise-time (4). The TTD PA signal normalized to remove any artifacts arising due to the optical absorption of the signal. Similarly, the time-windowed TTD PA signal for different temperatures are plotted as shown in FIG. 7 and corresponding rise-time for each is obtained. The square of this rise time (the squared rise time (tᵣ²), which is the viscosity feature) is plotted against their corresponding temperature by exponential fitting. It is observed that as the temperature increases the viscosity feature of the TTD PA signal reduces exponentially. FIG. 8 shows the exponentially fitted viscosity feature versus temperature graph. Literature reveal that the viscosity-temperature relation is given by—

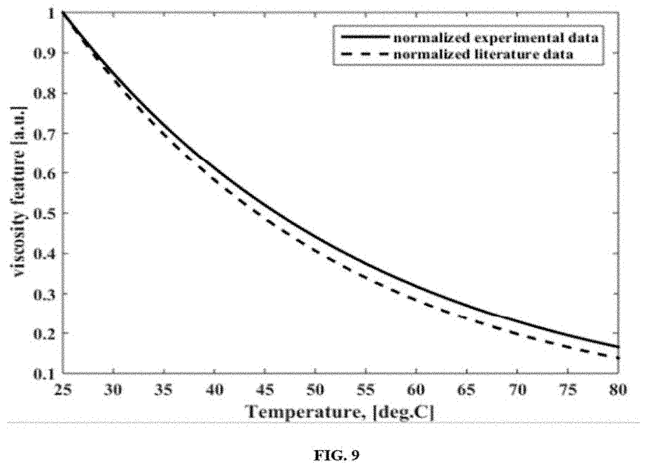

μ=a·e^{-bT} (8)

Where, T is temperature, a, b are constants and μ is the viscosity. For the oil sample SAE 20W40 the constants a, b obtained by standard viscometry test and can be found in the literature. Using these constants, the viscosity value is calculated at different temperatures from 30 degree (deg) Celsius (C) to 80 deg C. at an interval of 10 deg C. These calculated viscosity values are compared with the viscosity feature (obtained from the experiments) and plotted against their corresponding temperature as shown in FIG. 9. It can be observed from FIG. 9 that the system 100 computed viscosity matches closely with the standard viscosity value at different temperatures. The standard deviation of approximately 2% in the viscosity feature from the calculated viscosity value may be due to the experimental errors, which can be removed by proper calibration of the system for a given oil sample.

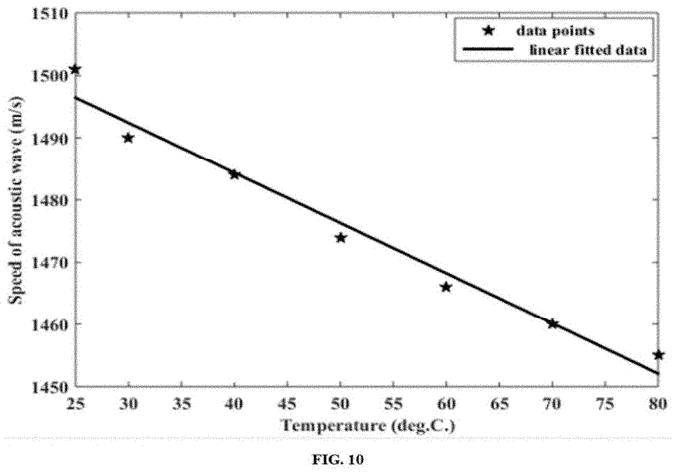

In the present experimental setting, digital thermometer is placed in the glass container to monitor the temperature. However, the speed of the PA wave is function of the temperature of a fluid. Moreover, literature suggest that the speed of sound varies inversely with respect to the temperature of the oil. The well-known relation for speed and time suggest that for a constant distance, speed and time are inversely related (i.e. speed=distance/time). In this study, as the same sample container is used, the path length of PA waves is constant. Hence, the temperature information can be obtained from FIG. 5 by obtaining the time delay. From FIG. 7 it can be inferred that the higher is temperature, it has more time delay or lesser speed of PA waves. FIG. 10 shows the variation in speed of PA wave with respect to the temperature.

Hence, by inferring the speed of PA wave and viscosity feature from the transformed time domain PA signal, the viscosity temperature information of the lubrication oil can be obtained.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for determining viscosity-temperature variation of a lubricant, the method comprising:
initiating, by one or more hardware processors, an iterative process of viscosity-temperature variation determination of the lubricant, for a predefined number of successive time instances, wherein the lubricant is held by a container of a machine that is monitored for predicting machine health thereof, wherein steps of each iteration for a current time instance further comprises:
triggering an excitation signal having a predefined frequency sweep for generating an intensity modulated Continuous-Wave (CW) laser via a CW laser diode placed in an excitation circuit to irradiate the lubricant using the intensity modulated CW laser;
receiving, by an ultrasound sensor, a Photo Acoustic (PA) signal produced within the lubricant irradiated with the intensity modulated CW laser;
processing, by a Vector Network Analyzer (VNA), the PA signal with reference to the excitation signal to generate an in-phase (I) component and a quadrature phase (Q) component of the PA signal in a frequency domain;
generating, by the one or more hardware processors, a PA analytical signal in the frequency domain from the I component and the Q component;
generating, by the one or more hardware processors, a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d);
generating, by the one or more hardware processors, a normalized first peak by amplitude normalization of the first peak after time-windowing the first peak from the TTD PA signal;
determining, by the one or more hardware processors, a rise time (tᵣ) of the PA signal by computing a time interval of the normalized first peak to rise from a pre-defined minimum amplitude percentage of a peak amplitude of the normalized first peak to a maximum amplitude percentage of the peak amplitude;
determining, by the one or more hardware processors, a viscosity (μ), in terms of a viscosity feature, of the lubricant based on the rise time (tᵣ) of the first peak, wherein the viscosity feature is directly proportional to a squared rise time (tᵣ²);
determining, by the one or more hardware processors, an acoustic velocity of the PA signal based on the peaking time instance of the first peak and the distance (d); and
determining, by the one or more hardware processors, a temperature (T) of the lubricant from the acoustic velocity, wherein the temperature is inversely proportional to the acoustic velocity of the PA signal;
recording, by the one or more hardware processors, a) the viscosity (μ) of the lubricant in terms of the viscosity feature and b) the temperature (T) of the lubricant determined in each iteration;
analyzing, by the one or more hardware processors, whether a change in the viscosity (μ) with respect to the temperature (T) is constant over a defined operating temperature range of the machine; and
predicting, by the one or more hardware processors, health of the machine as approaching a failure state, if the change in the viscosity is beyond a variation threshold indicating a drop in quality of the lubricant beyond an acceptable limit.

2. The method of claim 1, further comprising generating, by the one or more hardware processors, an alert indicating health of the machine as approaching the failure state if the change in the viscosity is beyond the variation threshold.

3. The method of claim 1, wherein relation between the viscosity (μ) of the lubricant and the squared rise time (tᵣ²) of the first peak is derived based on a) inverse proportionality relation between the viscosity (μ) and an acoustic frequency (f) of the lubricant, and b) inverse proportionality relation between the rise time (tᵣ) and the acoustic frequency (f) of the lubricant.

4. The method of claim 1, wherein the predefined frequency sweep is based on bandwidth of the ultrasound sensor.

5. A system for determining a viscosity-temperature variation of lubricant, the system comprising:
a viscosity-temperature computation module;
a Vector Network Analyzer (VNA);
CW laser driver with DC power supply unit;
CW laser diode;
a lubricant;
a collimator; and
an ultrasound sensor; wherein the viscosity-temperature computation module comprises:
a memory storing instructions;
one or more Input/Output (I/O) interfaces; and
one or more hardware processors coupled to the memory via the one or more I/O interfaces, wherein the one or more hardware processors are configured by the instructions to:
initiate an iterative process of the viscosity-temperature variation determination of the lubricant, for a predefined number of successive time instances, wherein the lubricant is held by a container of a machine that is monitored for predicting machine health thereof, wherein steps of each iteration for a current time instance further comprises:
triggering an excitation signal having a predefined frequency sweep for generating an intensity modulated Continuous-Wave (CW) laser via the CW laser diode placed in an excitation circuit, driven by the CW laser driver with DC power supply unit, to irradiate the lubricant using the intensity modulated CW laser;
receiving, via the ultrasound sensor, a Photo Acoustic (PA) signal produced within the lubricant irradiated with the intensity modulated CW laser;
processing via the VNA 104, the PA signal with reference to the excitation signal to generate an in-phase (I) component and a quadrature phase (Q) component of the PA signal in a frequency domain;
generating a PA analytical signal in the frequency domain from the I component and the Q component;
generating a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d);
generating a normalized first peak by amplitude normalization of the first peak after time-windowing the first peak from the TTD PA signal;
determining a rise time (tr) of the PA signal by computing a time interval of the normalized first peak to rise from a pre-defined minimum amplitude percentage of a peak amplitude of the normalized first peak to a maximum amplitude percentage of the peak amplitude;
determining a viscosity (μ), in terms of a viscosity feature, of the lubricant based on the rise time (tr) of the first peak, wherein the viscosity feature is directly proportional to a squared rise time (tr2);
determining an acoustic velocity of the PA signal based on the peaking time instance of the first peak and the distance (d); and
determining a temperature (T) of the lubricant from the acoustic velocity, wherein the temperature is inversely proportional to the acoustic velocity of the PA signal;
record a) the viscosity (μ) of the lubricant in terms of the viscosity feature and b) the temperature (T) of the lubricant determined in each iteration;
analyze whether a change in the viscosity (μ) with respect to the temperature (T) is constant over a defined operating temperature range of the machine; and
predict health of the machine as approaching a failure state, if the change in the viscosity is beyond a variation threshold indicating a drop in quality of the lubricant beyond an acceptable limit.

6. The system of claim 5, wherein the one or more hardware processors are further configured to generate an alert indicating health of the machine as approaching the failure state if the change in the viscosity is beyond the variation threshold.

7. The system of claim 5, wherein a relation between the viscosity (μ) of the lubricant and the squared rise time (tᵣ²) of the first peak is derived based on a) inverse proportionality relation between the viscosity (μ) and an acoustic frequency (f) of the lubricant, and b) inverse proportionality relation between the rise time (tᵣ) and the acoustic frequency (f) of the lubricant.

8. The system of claim 5, wherein the predefined frequency sweep is based on bandwidth of the ultrasound sensor.

9. The system of claim 5, wherein a beam diameter and focusing of the intensity modulated CW laser, controlled via the collimator, is tunable and determined based on industrial set up of the machine.

10. One or more non-transitory machine-readable information storage mediums comprising one or more instructions which when executed by one or more hardware processors cause:
initiating an iterative process of viscosity-temperature variation determination of a lubricant, for a predefined number of successive time instances, wherein the lubricant is held by a container of a machine that is monitored for predicting machine health thereof, wherein steps of each iteration for a current time instance further comprising:
triggering an excitation signal having a predefined frequency sweep for generating an intensity modulated Continuous-Wave (CW) laser via a CW laser diode placed in an excitation circuit to irradiate the lubricant using the intensity modulated CW laser;
receiving, by an ultrasound sensor, a Photo Acoustic (PA) signal produced within the lubricant irradiated with the intensity modulated CW laser;
processing, by a Vector Network Analyzer (VNA), the PA signal with reference to the excitation signal to generate an in-phase (I) component and a quadrature phase (Q) component of the PA signal in a frequency domain;
generating a PA analytical signal in the frequency domain from the I component and the Q component;
generating a Transformed Time Domain (TTD) PA signal from the PA analytical signal in the frequency domain by applying frequency to time domain transformation, wherein the TTD PA signal comprises a) a first peak that corresponds to the PA signal produced within the lubricant, and b) subsequent one or more descending peaks generated as a result of a reflection of the PA signal back and forth from walls of the container holding the lubricant, wherein a peaking time instance of the first peak is indicative of time elapse of the PA signal in reaching the ultrasound sensor from a point of generation of the PA signal inside the container at a distance (d);
generating a normalized first peak by amplitude normalization of the first peak after time-windowing the first peak from the TTD PA signal;
determining a rise time (tᵣ) of the PA signal by computing a time interval of the normalized first peak to rise from a pre-defined minimum amplitude percentage of a peak amplitude of the normalized first peak to a maximum amplitude percentage of the peak amplitude;
determining a viscosity (μ), in terms of a viscosity feature, of the lubricant based on the rise time (tᵣ) of the first peak, wherein the viscosity feature is directly proportional to a squared rise time (tᵣ²);
determining an acoustic velocity of the PA signal based on the peaking time instance of the first peak and the distance (d); and
determining a temperature (T) of the lubricant from the acoustic velocity, wherein the temperature is inversely proportional to the acoustic velocity of the PA signal;
recording a) the viscosity (μ) of the lubricant in terms of the viscosity feature and b) the temperature (T) of the lubricant determined in each iteration;
analyzing, whether a change in the viscosity (μ) with respect to the temperature (T) is constant over a defined operating temperature range of the machine; and
predicting health of the machine as approaching a failure state, if the change in the viscosity is beyond a variation threshold indicating a drop in quality of the lubricant beyond an acceptable limit.

11. The one or more non-transitory machine-readable information storage mediums of claim 10, wherein the one or more instructions which when executed by the one or more hardware processors further cause generating an alert indicating health of the machine as approaching the failure state if the change in the viscosity is beyond the variation threshold.

12. The one or more non-transitory machine-readable information storage mediums of claim 10, wherein relation between the viscosity (μ) of the lubricant and the squared rise time (tᵣ²) of the first peak is derived based on a) inverse proportionality relation between the viscosity (μ) and an acoustic frequency (f) of the lubricant, and b) inverse proportionality relation between the rise time (tᵣ) and the acoustic frequency (f) of the lubricant.

13. The one or more non-transitory machine-readable information storage mediums of claim 10, wherein the predefined frequency sweep is based on bandwidth of the ultrasound sensor.
